(19) United States
(12) Patent Application Publication
(10) Pub. No.: US 2002/0032646 A1
(43) Pub. Date: Mar. 14, 2002

(54) System and method of automated brokerage for risk management services and products

(76) Inventors: Francis Sweeney, Pennington, NJ (US); Vincent Farina, Hamilton, NJ (US)

Correspondence Address: MATHEWS, COLLINS, SHEPHERD & GOULD, PA, 100 THANET CR, SUITE 306, PRINCETON, NJ, 08540, US

(21) Appl. No.: 09/948,419

(22) Filed: Sep. 7, 2001

Related U.S. Application Data
(60) Provisional application No. 60/231,472, filed on Sep. 8, 2000.

(51) Int. Cl. G06F 17/60

(52) U.S. Cl. 705/38

(57) ABSTRACT

A system for automated risk management on an automated system used by a plurality of users provides a dynamic interaction between buyers and sellers, which maintains confidentiality, enables efficient decisions to be made concerning reinsurance products. The system includes: means for authenticating the plurality of users to access to the automated system; means for providing a database of transactional postings; communication means for a first user of the plurality of users to access the database of transactional postings including a specific posting by a second user of the plurality of users; anonymous communication means for private anonymous communication between the first user and the second user; wherein the first user and the second user are identified to the automated system.

### CROSS REFERENCES TO RELATED APPLICATIONS

This application claims the benefit of U.S. Provisional patent application Serial No. 60/231,472, filed on Sep. 8, 2000.

### FIELD OF THE INVENTION

This invention relates to network-based communication systems and more particularly to the management of information about risk management products over a communication network.

### BACKGROUND OF THE INVENTION

Insurance provides a method of sharing risk. Insurers often seek to share their risk through reinsurers, thus reducing the impact of a single catastrophic event on their financial stability. Buyers and sellers of reinsurance in today's market look to intermediaries and financial services companies to offer services including providing brokerage services.

Reinsurance coverage is typically arranged for the various lines of property casualty insurance including business insurance, commercial auto, aviation, energy, financial guarantee, ocean marine, inland marine, surety, professional liability, and workers' compensation, among others.

The business relationship between a reinsurance seller and a reinsurance buyer has long been controlled by brokers, dealing through personal contacts, maintaining tight control of financial and business information. Brokers typically charge a fee based on a percentage of the reinsurance cost, such as fifteen percent. The nature of reinsurance business practices and customs make an open brokerage model or open market exchange undesirable. There is a need to be able to automate the buying and selling of reinsurance products while maintaining anonymity and confidentiality. It would be desirable to provide powerful integrated searching tools, information retrieval mechanisms, vendor request mechanisms and management tools that will assist risk managers in making and managing their procurement decisions.

### SUMMARY OF THE INVENTION

The present invention is an integrated management system for risk management brokerage. A dynamic interaction between buyers and sellers, which maintains confidentiality, enables efficient decisions to be made concerning reinsurance products.

### BRIEF DESCRIPTION OF THE DRAWINGS

A more complete understanding of the present invention may be obtained from consideration of the following description in conjunction with the drawing in which:

FIG. 1 is a stylized overview of interconnected computer system networks;

FIG. 2 is an exemplary user screen displaying representative items used for filtering;

FIG. 3 is an exemplary Market Board display;

FIG. 4 is an exemplary display of the detailed posting and communication information for a specific posting; and,

FIG. 5 is a block diagram of the sequence of steps that may occur during use of the system.

### DETAILED DESCRIPTION OF VARIOUS ILLUSTRATIVE EMBODIMENTS

Although the present invention is particularly well suited for brokerage of reinsurance services and products and shall be so described, the present invention is equally well suited for use in the brokerage of other services and products, which require similar confidentiality and anonymity.

Although the present invention, system and method of automated brokerage for risk management services and products (automated risk management system), is particularly well suited for use with the Internet and shall be so described, the present invention is equally well suited for use in other network communication systems including but not limited to an Intranet, extranet, Interactive television (iTV) and similar interactive networked communication systems.

Although the automated risk management system is particularly well suited for implementation as an independent software systems and shall be so described, the present invention is equally well suited for implementation as a functional/library module, an applet, a plug in software application, as a device plug in, and in a microchip implementation.

The Internet is a worldwide system of computer networks—a network of networks in which users at one computer can obtain information from any other computer (and communicate with users of the other computers). The Internet was conceived by the Advanced Research Projects Agency (ARPA) of the U.S. government in 1969 and was first known as the ARPANet. The original aim was to create a network that would allow users of a research computer at one university to be able to communicate with research computers at other universities. A key design element of ARPANet that, because messages could be routed or rerouted in more than one direction during the course of a communication link, the network could continue to function even if parts of it were destroyed such as by a military attack or natural disaster.

The Internet has evolved into a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called Transmission Control Protocol/Internet Protocol (TCP/IP).

For many Internet users, electronic mail (e-mail) has essentially all but replaced the Postal Service for short written transactions. E-mail is the most widely used application on the Internet. Live “conversations” can be carried on with other computer users, using Internet Relay Chat (IRC) and various Instant Messenger (IM) applications. More recently, Internet telephony hardware and software allows real-time voice conversations.

The most widely used part of the Internet is the World Wide Web (often abbreviated “WWW” or simply called “the Web”). The most outstanding feature of the Web is its extensive use of hypertext, which is a method of instant cross-referencing. In most Web sites, certain words or phrases appear in text of a different color than the rest; often this text is also underlined. When one of these words or phrases is selected, it's a hyperlink, transferring the user to the site or page that is relevant to this word or phrase. Sometimes there are buttons, images, or portions of images that are “clickable” which act as a hypertext link when selected. Using the Web provides access to millions of pages of information. Web “surfing” is done with a Web browser; the most popular of which presently are Netscape Navigator and Microsoft Internet Explorer. The appearance of a particular Web site may vary slightly depending on the particular browser used. Recent versions of browsers have plug-ins, which provide animation, virtual reality, sound, and music. Because the Internet evolved from the ARPAnet, a research experiment that supported the exchange of data between government contractors and (often academic) researchers, an on-line culture developed that is alien to the corporate business world. Although not designed to make commercialization easy, commercial publishing and various forms of e-commerce have rapidly evolved which over the Internet. In part it is the very ease that anyone can publish a document that is accessible by a large number of people that makes electronic publishing attractive. Setting up e-commerce provides low overhead while reaching a worldwide market 24 hours a day. The growth and popularity of the Internet is providing new opportunities for commercialization including but not limited to Web sites driven by electronic commerce, ad revenue, branding, database transactions, and intranet/extranet applications.

Domain names direct where e-mail is sent, files are found, and computer resources are located. They are used when accessing information on the Web or connecting to other computers through Telnet. Internet users enter the domain name, which is automatically converted to the Internet Protocol address by the Domain Name System (DNS).

E-mail was one of the first services developed on the Internet. Today, e-mail is an important service on any computer network, not just the Internet. E-mail involves sending a message from one computer account to another computer account. E-mail is used to send textual information as well as files, including graphic files, executable files, word processing and other files. E-mail is becoming a popular way to conduct business over long distances. Using e-mail to contact a business associate can be faster than using a voice telephone, because the recipient can read it at a convenient time, and the sender can include as much information as needed to explain the situation.

File Transfer Protocol (FTP), a standard Internet protocol, is the simplest way to exchange files between computers on the Internet. Like the Hypertext Transfer Protocol (HTTP), which transfers displayable Web pages and related files, and the Simple Mail Transfer Protocol (SMTP), which transfers e-mail, FTP is an application protocol that uses the Internet's TCP/IP protocols. FTP is commonly used to transfer Web page files from their creator to the computer that acts as their server for everyone on the Internet. It's also commonly used to download programs and other files to your computer from other servers.

On-line commerce, or “e-commerce”, uses the Internet, of which the Web is a part, to transfer large amounts of information about numerous goods and services in exchange for payment or customer data needed to facilitate payment. Potential customers can supply company with shipping and invoicing information without having to tie up sales staff. The convenience offered to the customer is that they don't have to drive around town all day looking for the product they want.

E-commerce businesses, while much talked about are still under going a shake out, changing their very methods of operations. Initially, web sites were simply information sites—on line advertisements and brochures. Even as customers flocked to web sites to make on line purchases, it became doubtful if most web based businesses could even turn a profit. The various e-commerce web sites fall into one of two groups: a pure web based business; or a brick-and-mortar business with an on-line presence. But any business selling goods requires a distribution network. In fact, the largest costs for e-businesses are typically warehouses and the associated distribution of products. Without innovative alternatives, the only real chance to survive is to have a strong established distribution network or to operate in a unique niche market.

Internet access through digital cell phones has gotten a lot of publicity recently. Unfortunately, most users of wireless application protocol (WAP) are frustrated by the limitations of calling up the World Wide Web on their cell phones: Anything more complex than a simple weather report, stock report or sports score is very awkward and time consuming to obtain.

A serious challenge to traditional long distance telephone service has evolved using the Internet. A number of new software and hardware products allow the use of a Voice over Internet Protocol (VoIP). The systems are now designed to be used with a normal telephone, eliminating the earlier requirements that users be setting at a computer connected to the Internet. Internet users now can get sound quality near to that of a traditional switched telephone.

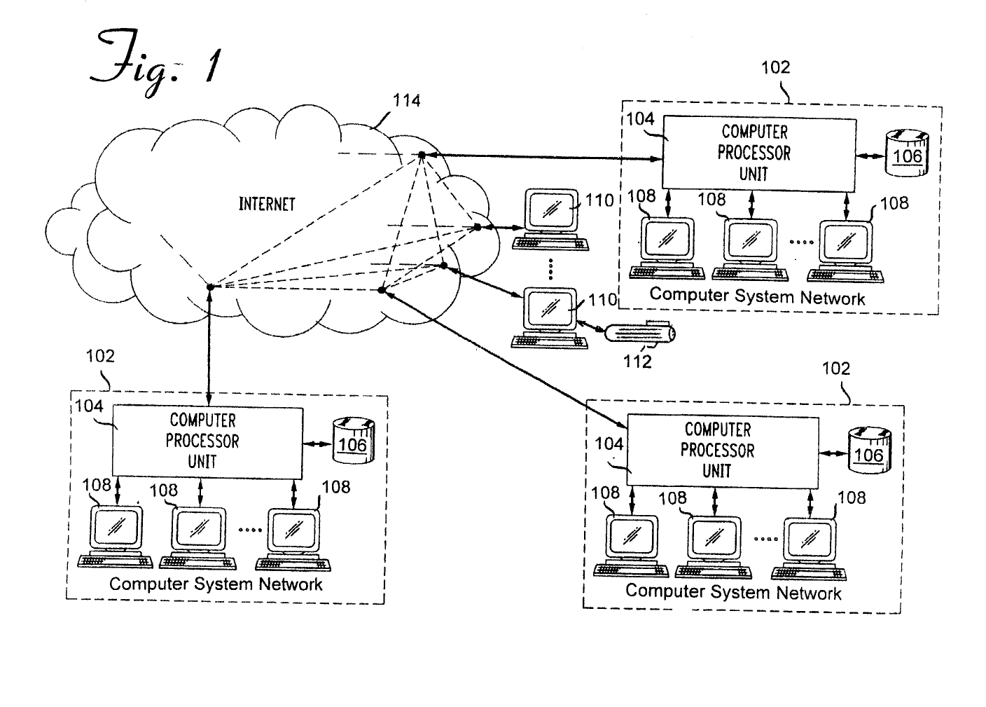

Referring to FIG. 1 there is shown a stylized overview of interconnected computer system networks. Each computer system network 102 contains a corresponding local computer processor unit 104, which are coupled to a corresponding local data storage unit 106 and network users 108. The local computer processor units 104 are selectively coupled to a plurality of users 110 through the Internet 114. Each of the plurality of users 110 may have various devices connected to their local computer systems such as scanners, bar code readers, RFID detectors and other interface devices 112. A user 110 locates and selects (such as by clicking with a mouse) a particular Web page, the content of which is located on the local data storage unit 106 of the computer system network 102, to access the content of the Web page. The Web page may contain links to other computer systems and other Web pages.

The automated risk management system is a web-based business-to-business solution that streamlines information and commerce among all members of the reinsurance industry while maintaining confidentiality and anonymity. Combining the essential elements of content, community, commerce and workflow processing, the present invention, system and method of automated brokerage for risk management services and products, provides robust portals that make it possible for hospitals, buyers and sellers of reinsurance products and services to interact in real time over the Internet.

The automated risk management system provides a business-to-business e-commerce solution for risk management. The automated risk management system is a low-cost global marketing tool, which empowers the end user to efficiently manage risk by creating new and speedier channels of distribution.

Exemplary business deals suitable for completion utilizing the present invention, system and method of automated brokerage for risk management services and products, range from product liability, credit risk and aviation covers for both commercial and space risk, to Y2K exposure, professional liability and traditional and non-traditional property multi and single risk placements as well as other services.

Users of the automated risk management system, whether they are from the risk bearing, brokering or risk management community access the live trading system at a predefined URL over the Internet. Users are able to organize and manage their risk portfolio by moving between their personal board showing deals they are participating in to the market board of all current live deals. By eliminating administrative bottlenecks and moving data from in-boxes to digital pipelines, the present invention reduces transaction costs, solidifies relationships with existing customers and attracts new ones.

The automated risk management system is far more than simply a bulletin board for those interested in trading and managing risk—it is an integrated Internet browser—based trading exchange system. The automated risk management system can be deployed to all end-users in an enterprise, enhancing productivity. The communication, document handling, tracking and negotiation tools embedded in the system and method allow users to complete all manner of transactions efficiently and effectively.

The automated risk management system is a horizontal trading platform linking other world markets and individual vertical electronic distribution networks, which is able to offer an extensive distribution channel for spreading risk and an industry-wide forum to facilitate the development of relationships, products and transactions.

The automated risk management system offers a number of key business benefits to the risk bearing community including tools to share information, negotiate terms and complete transactions efficiently and effectively. Given the above efficiencies, markets may adjust their risk portfolio throughout the year as market or pricing conditions alter. A global open posting board gives parties access to deals they might otherwise not have seen. Users are able to form relationships with new business partners around the world, including direct relationships with corporate risk managers and other ceding companies. Parties are able to complete real-time transactions reacting to political, economic or climatic events, 24 hours a day, 7 days a week.

The automated risk management system provides enhanced functionality to allow users to market individual deals through a private network, linking in business partners who are not system subscribers to utilize the efficiencies of the trading system for individual deals.

Matching tools within the present invention allow underwriters to specify precisely the types of deal they are interested in pursuing. The automated risk management system will then automatically match the underwriter's requirements to all new deals on the global posting board and alert them accordingly.

The automated risk management system can be implemented through a variety of software/computer tools, which are known to those, skilled in the art. The architecture and software development tools which are used to implement a particular embodiment of the present invention, system and method of automated brokerage for risk management services and products may include client/server programming language such as JAVA, HTML, XML, PERL, data base products such as Oracle, SQL Server, etc. The specific choice of the architecture, hardware and communication tools can easily be made by one skilled in the art of software development.

The automated risk management system is a Web-enabled technology where all users are able to access all system functionality using Internet connections. Any software, such as plug-ins required by the user, is made available for download from the web site or a link provided by the web site.

The automated risk management system is compatible with the functionality of widely-used Web Browsers, including Microsoft Internet Explorer 4.0, and each of its subsequent versions, and Netscape 4.0, and each of its subsequent versions, but is not limited to these software systems alone.

The automated risk management system resides on a secure Web site which is protected by user passwords, encryption and any other security systems necessary to prevent any unauthorized access to the Web site and the associated data.

The automated risk management system includes automatic, real-time updates of using auto-refresh functionality, “push” technology, intelligent agents, or similar means. The updates avoid any interference with ongoing system use by traders. The system includes a system clock showing the correct time in GMT or other selected time zone (e.g., EST). This utility enables users to convert between time zones to determine time in other world regions or ascertain overlapping business hours between major reinsurance markets.

The automated risk management system includes on-line registration forms enabling companies and users to enter information requested as part of the subscription process. Company set-up information shall include company name; company type (e.g., commercial risk-bearer, broker, corporate self-insured, etc.); company administrative information (i.e., mail address; billing address, e-mail address); and other informational items specified. User set-up information shall include user name; user administrative information (i.e., mail address, telephone number, e-mail, etc.); user trading privileges (i.e., view; post; confirm; change authorities of other users); security information (i.e., passwords, Q&A to obtain forgotten password); and other informational items specified. This semi-automated process shall allow an operator of the system to make rapid determinations on subscription applications and other decisions relating to company participation in the market (i.e., the Subscription Agreement would be executed separately off-line, although this document could be made available electronically as well). Information collected at the registration stage and routed to an Administration Data Base will also be used for general administrative purposes (e.g., billing, marketing, etc.) and certain items (e.g., company class, market maker status) may be used to delimit company/user trading privileges or aid in distribution/filtering of postings and communications in the marketplace.

Exemplary embodiments of this feature follows. Initially, a non-subscribing company (i.e., including its authorized users) completes the on-line registration form expressing interest in the Subscription; this information is routed to the Administration database. Following any necessary re-entry or editing of information, Administration approves/disapproves the company/user registrations, and if approved, the Subscriber and its users are given full trading privileges on the Trading System A non-subscribing company completes the on-line registration form expressing interest in a Buyer License; this information is routed to the Administration database. Following any necessary re-entry or editing of information, Administration approves/disapproves the Buyer License. If approved, the Buyer is given access to entire Market Board (i.e., it receives all postings), but the Posting template automatically restricts transaction interest to “cede” only; the Buyer cannot indicate “assume” or “swap” risk as the “transaction interest” on a Posting template.

A non-subscribing company completes the on-line registration form expressing interest in using the Post-A-Risk facility; this information is routed to the Administration database. Administration then approves/disapproves Post-A-Risk the registration. If approved to post the risk, the Risk Poster is given access only to the Posting template and the Private Deal Board (i.e., including all communication facilities needed to conclude the deal) showing only the posting originated the Risk Poster, although Administration shall have discretion to grant access to the Market Board as a means to encourage full subscription by the Risk Poster.

A Subscriber completes the on-line registration form expressing interest in acting as Market Maker; this information is routed to the Administration database. Administration then approves/disapproves the Market Maker registration. If other Subscribers elect to use the Market Maker option specified on their Posting template, these designated postings are routed initially to any approved Market Makers for a specified time period (e.g., 72 hours) prior to their market-wide distribution.

A Subscriber completes the on-line registration form expressing interest in operating either a Continuous (i.e., enabling multiple deals over an extended time period) or a Temporary Private Network (i.e., enabling a single deal over a specified time period). This registration will also identify other non-subscribing trading parties to be enrolled in the Private Network, and any additional registration required from these non-subscribing parties is entered by either the Subscriber or these parties. This registration information is routed to the Administration database. Administration approves/disapproves Private Network registration and assigns appropriate passwords/security clearances for the Network. Enrollees are given access only to postings distributed via the Private Network.

Each Subscriber completes the on-line registration form indicating its company name and company type (e.g., commercial risk-bearer, broker, etc.). Administration implements market guidelines allowing each Subscriber to distribute its postings to other subscribing companies on a selective basis. Under these guidelines, the Subscriber uses the Posting template to include/exclude certain company types and include/exclude certain companies by name. These postings appear solely on the screens of those companies authorized to view the postings.

The automated risk management system provides Administration with suitable, real-time access to review, approve/disapprove and edit all information compiled in company/user registration system.

The automated risk management system provides Administration with suitable access to monitor Trading System activity and communications on a real-time basis. Examples of such monitoring functions include access to and monitoring of user log-ons/log-offs, usage of system applications, on-line communications (i.e., including O-T-B Postings & Responses; A-Mails & Aliases (i.e., ability to associate aliases with company/user names); Name Exchanges; E-Mails; Document Center; etc.) and Trade Reports. The software includes such sorting/filtering functions as may be needed to support these monitoring functions in light of the anticipated usage rates for the system.

The automated risk management system enables Administration to monitor the status and progress of individual postings/deals in support of critical administrative and market oversight functions (e.g., collection of trading fees).

The automated risk management system enables Administration to undertake the automatic transmittal of notices to users as may be appropriate to assist in the collection of all trading fees owed to the operator or perform other critical administrative functions. In particular, the automated risk management system includes a function enabling the transmittal of a notice/certification following a Name Exchange between transacting parties.

The automated risk management system enables the operator to transfer limited administrative functions (e.g., review of log-ons/log-offs) to subscribing companies to support their ability to monitor and supervise their own system users.

### User Profile Screens

The automated risk management system enables companies to modify company registration information upon proper authorization by Administration.

The automated risk management system enables users to modify user registration information (i.e., passwords, trading authorities, etc.) upon proper authorization by Administration. Users are able to modify the pre-set time limit for automatic log-off trading sessions following periods of inactivity.

The automated risk management system enables users to configure posting templates to authorize the distribution of postings based on selected criteria (e.g., company type; individual company; market maker election; etc.). The automated risk management system enables users to pre-configure posting templates to simplify expedite posting activity.

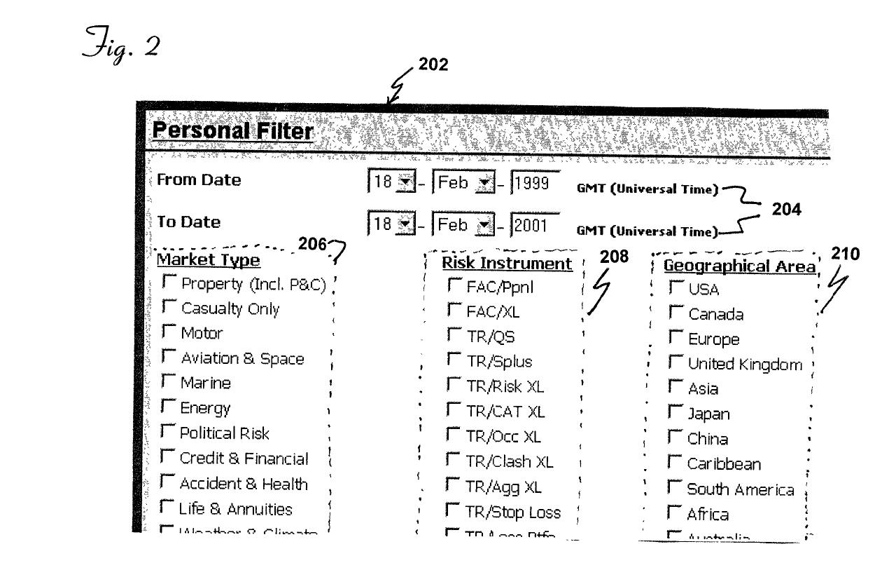

The automated risk management system enables users to sort/filter postings & trades to allow their selective display based upon market type, instrument type or other parameters specified in posting templates or trade reports. Referring to FIG. 2 there is shown an exemplary user screen 202 displaying representative items used for filtering. A date range 204 can be used to narrow the postings being viewed along with market type 206, risk instrument 208 and geographical area 210. The automated risk management system also enables the distribution of alerts for new postings, trade reports or communications meeting pre-selected criteria (e.g., new Casualty postings; new Property ILW trades; all new communications relating to Deal #591). These alerts shall include a hot-link to the item requested.

### Market Board & Private Deal Board

A Home Page includes buttons/icons for the Market Board; Private Deal Board; Communications Panel; Trading Desk; and other buttons/icons as specified by the operator. The Home Page includes a window for CAT TV and multiple horizontal or vertical “tickers” for completed trades; active postings; real-time news and weather alerts. The Home Page includes an automatic call-up of the Market Board as it stands at the time of the user log-on.

The automated risk management system includes active “ticker” devices that enable users to click on individual ticker items to get more detailed contents. Tickers shall appear on all trading screens, but users should have the ability to disable the tickers to protect bandwidth or minimize distractions.

The Home Page includes a window in its lower left-hand corner to enable the distribution of streaming video for CAT TV. The Trading System includes a user-friendly set-up feature enabling each user to download any additional system (e.g., Real Video) required to operate the CAT TV window. CAT TV shall appear on all trading screens, but users should have the ability to disable the CAT TV window to protect bandwidth or minimize distractions.

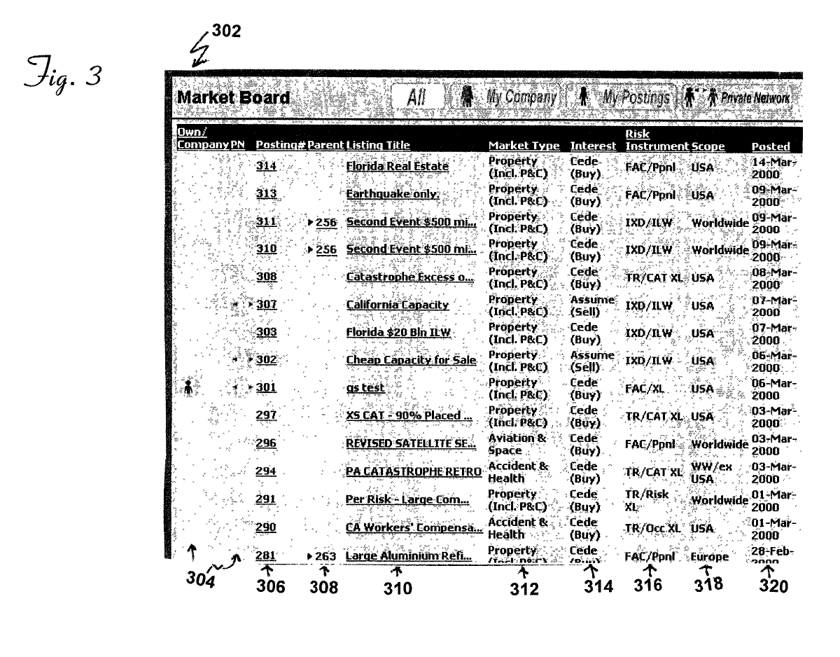

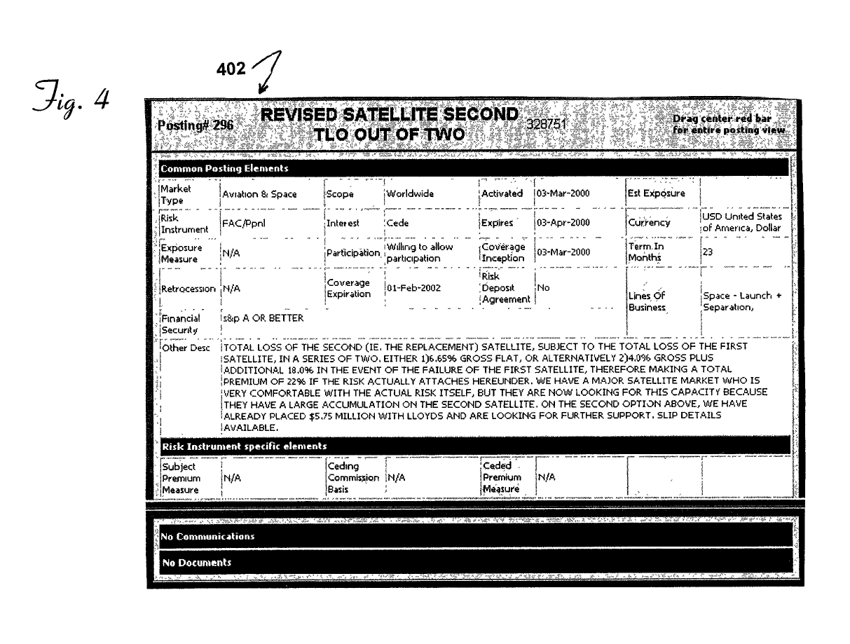

Referring to FIG. 3 there is shown an exemplary Market Board display 302. The display contains all postings (i.e., those distributed to the entire market) showing selected fields common to all postings (e.g., posting number 306, parent posting 308, listing title 310, market type 312, transaction interest 314, risk instrument 316, geographical scope 318, posting date 320, as well as other identifiers 304.). The Market Board includes standardized sorting functions as tabs or buttons (e.g., Market tabs, FAC Board, ILW Board, Weather Board) and more specialized search functions (e.g., all postings within past 30 days). The Market Board includes appropriate markings to identify and highlight each user's own postings (i.e., user originated or responded to these deals); any new postings on the Board; any significant responses to postings (i.e., as measured by # hits, off-board communications via A-Mail/E-Mail or other suitable parameters). User should be able to click on a “More Details” field under each posting (such as posting number 296) to go to the detailed posting and communication information for a specific posting 402 shown in FIG. 4.

The Trading System includes a means by which a user may elect to adopt a Trading Screen, including, if practicable, a real-time version of the Market Board, as the user's desktop screen saver. The Trading System provides a user-friendly set-up feature enabling each user to download any additional system required to install and update the screen saver device.

The automated risk management system provides clearly marked functionality enabling users to originate postings/deals from either the Market Board or the Private Deal Board. The posting procedure provides completion of a posting template and distribution of any supporting documents (e.g., slip, underwriting submission, etc.) via the Document Center. Each new posting shall be assigned a unique posting # by the system. Posting data from certain posting fields (i.e., those selected by Administration) shall be automatically exported to the “ticker” once a posting has been submitted by a user. A posting originated from within a user's company should be clearly marked.

Posting templates are designed to include highly structured fields to aid filtering & alerting functions; export of trading data to market “tickers,” and internet/wireless distribution channels; single-entry trade reporting; deal tracking by the user; and linkage to appropriate trading desk (e.g., Aviation & Space), analytics and other functionalities. Some posting fields will be common to all market postings, while other fields will be tied to market type, instrument type or other parameter specified in the posting. The posting template also includes other key user elections relating to distribution (e.g., election to send initially to Market Makers) and other posting attributes. Postings are designed to be anonymous only; efforts will accordingly be made to minimize free-form communication and filter out obvious name give-ups as part of the posting process.

To provide greater user convenience in originating postings, the System enables users to download blank posting templates to their PC desktops and subsequently upload completed postings to the Trading System from their PC desktops.

The automated risk management system provides a button/icon enabling users to research market statistics include an index of completed Trade Reports and an index of Expired Postings. This facility provides sorting/filtering and search tools similar to those already described for Postings.

The main automated risk management system screen provides convenient access to information and analytics portals (e.g., catastrophe modeling services), and ability for efficient upload/download of data to and from these portals.

The automated risk management system enables the user to reach a Private Deal Board from either a sort tab on the Market Board or a separate button/icon on the Home Page. The Private Deal Board will display only those postings of particular interest to the individual trader (i.e., those the user has originated or responded to). User should be able to click on a “More Details” field under each posting to go to the detailed posting and communication information for a specific posting.

### Deal-specific Communications In-box

When a user clicks on the “More Details” feature, the automated risk management system displays the complete posting terms on the left-hand side of the screen, including any additional fields not shown on the Market Board. Posting details provides a unique posting # (i.e., in the top-left comer); information on user “interest” in deal (i.e., originated by user; responded to by user; no user interest); posting fields common to all postings; and posting fields specific to certain market/instrument types. Postings provide hot-links to graphics, databases or other links that can be used to characterize the posting.

The automated risk management system provides an Integrated Communications In-box that compiles and displays all communications for each specific deal (i.e., including copies of any communications originated by the user) in reverse chronological order. Each communication shall be properly identified by deal #; communication type (e.g., E-Mail, A-Mail, etc.); date & time sent or received; identity of sender or recipient (e.g., company name or alias); description; confirmation of receipt, options to delete, export or archive; and any other fields requested by the operator. User shall be able to click on a specific communication to get access to contents or link to appropriate communication facility (e.g., Document Center). The automated risk management system enables users to sort/filter communications by date, sender/recipient, communication type or other appropriate groupings.

The automated risk management system provides an Integrated Communications Panel enabling efficient response by variety of means, including O-T-B Posting/Response; Response Card indicating fields to be filled in by recipient (i.e., credit rating); A-Mail; Name Exchange; User Directory; E-Mail; Document Center (i.e., space in Document Center shall be automatically allocated by deal); Trade Report; and Trade History. Based on further cost-benefit analysis, the operator of the system can expand the set of on-line communication facilities to include the following: trade calendar (i.e., enabling users to distribute digital “calendars” outlining their deal schedules); digital signature (i.e., enabling electronic authorization of trade); deal auction & syndication system (i.e., facilitating one-to-one or one-to-many transactions); on-line trader directory (i.e., to set up real-time communications without appointments); real-time text dialog; internet telephony; video conferencing, and other facilities.

The automated risk management system provides users with the option to archive each communication in a Trade History for the specific deal. The screen format for Trade History (e.g., identifying communication type, sender/recipient name, date & time-stamping, etc.) resembles the format used for both the General and Deal-Specific Communication In-boxes.

To curtail need for multiple data entry by users, the automated risk management system automatically imports relevant data from selected posting fields to the corresponding Trade Report fields. The Trade Report template will also include any additional blank fields (e.g., final ROL) needed to complete trade report. Selected data (i.e., determinations to be made by Administration) from completed Trade Reports shall be automatically exportable to both the Completed Trades “Ticker” and administrative billing system used to send out invoices for Trading Fees. A Trade Report originated from within a user's company should be clearly marked.

The automated risk management system provides a link to the main Trading Desk, or other appropriate on-line help facility (e.g., Aviation Trading Desk for posted aviation deals).

### General Communications In-Box (All Trade-related Communications)

The automated risk management system provides an Integrated Communications In-box that compiles and displays all trade-related communications (i.e., across all deals) and other communications on the system in reverse chronological order based upon their receipt by the user. This general communications in-box provides similar format (i.e., see fields specified above) and functionality (e.g., sorting) as the deal-specific communication in-boxes, except that the general in-box should also enable a user to link to the deal-specific in-box (e.g., by clicking on the deal #) and to route any unidentified/unclassified deal-specific communications to appropriate deal-specific in-box.

### Additional Requirements Relating to Specific Communication Functions

The automated risk management system provides a communication functionality enabling users to engage in direct, anonymous messaging and communication (i.e., including documents and other attachments) between one another. The A-Mail (anonymous mail) function provides the assignment of random numeric/alphabetic aliases (i.e., aliases will not be selected by users) to differentiate multiple traders involved in a particular deal. This function shall also include selected standard E-Mail features as may be determined by the system operator. A-Mail messages are captured on the operator's servers to ensure immediate, reliable delivery, but they are also transferable via corporate e-mail outlets to provide user convenience. The automated risk management system provides a notice/alert when an A-Mail is received for specific deal (“You have an A-Mail relating to Deal 591 . . . ”) with a hot-link to the A-Mail. Original posting information is visible when composing an A-Mail.

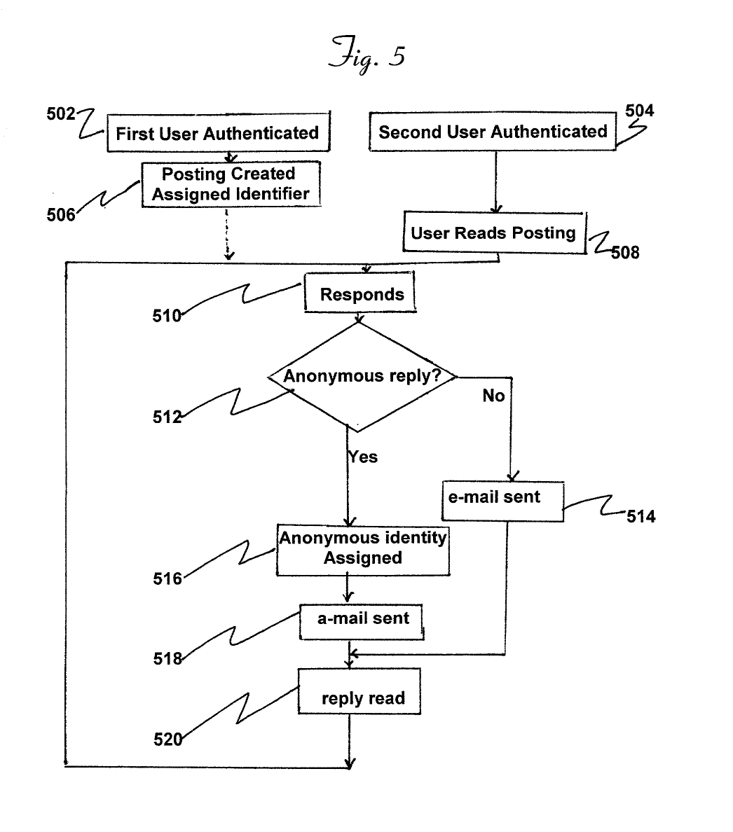

Referring to FIG. 5 there is shown one embodiment of the sequence of steps that may occur during use of the system. A first user is authenticated 502 and a second user is authenticated 504 for accessing the automated risk management system. The first authenticated user can create a posting 506 which is assigned a posting identifier. The second authenticated user can read the postings 508. A response can be generated to a communication or a message in step 510. The authenticated user can select if the response is to be anonymous in step 512. If the response is not anonymous, then a standard e-mail is sent in step 514. If the response is to be anonymous, then an anonymous identity is assigned in step 516. The anonymous message is sent in step 518, having all of the standard e-mail features such as the ability to make attachments and send copies. The reply is read in step 520.

The automated risk management system posting and a-mail sequence is designed to ensure that anonymity of the transacting parties; this approach assists the system operator in keeping transactions on the system. The system benefits from the inclusion of filtering system that could track any Postings, Responses or A-Mail communications that include proper names, telephone numbers, fax numbers, e-mails or other means to circumvent the use of the Name Exchange facility for cross-identification of interested parties.

The automated risk management system provides communication functionality enabling users with a shared interest in a particular deal to engage in a simultaneous exchange of their company names/identities. Name exchanges are captured on the system operator's servers to ensure immediate, reliable delivery, but they should also be transferable via corporate e-mail outlets to provide user convenience. The automated risk management system provides a notice/alert when a Name Exchange is received for specific deal (“You have received a Name Exchange request relating to Deal 591 . . . ”) with a hot-link to the Name Exchange. Following the name exchange, an option to include the corporate logo in subsequent communications is included.

The automated risk management system provides communication functionality that enable rapid call-up of all trader names, and associated directory information (e.g., THE SYSTEM OPERATOR e-mail address) for the purpose of transmitting communications and documents to other system users via E-Mail, Document Center or other facilities. Since distribution lists are likely to be used repeatedly in the context of a specific deal (e.g., a pre-authorized panel of reinsurers), users are able to save, and then reuse, these distribution lists.

The E-Mail system provides the range of features and functionality that are standard for widely available commercial systems (e.g., address books, forwarding, etc.). Messages are captured on the system operator's servers to ensure immediate, reliable delivery, but they are also transferable via corporate e-mail outlets to provide user convenience. The E-Mail system provides a notice/alert when a party receives a new E-Mail for a specific deal (“You have received an E-Mail relating to Deal 591 . . . ”) with a hot-link to the E-Mail on the system. The E-Mail system provides internal tracking (e.g., return receipt requested) to confirm receipt by the intended party. Original posting information should be visible when composing a new E-Mail.

The Document Center plays a key role in handling the large volume of underwriting documents often associated with a deal. The facility has an attractive, user-friendly format allowing easy access to major functions such as document viewing or check-in/check-out. The facility enables distribution of a range of file types (e.g., text; spreadsheets; video clips; pictures/images; e-mails; sound clips; graphs; bar charts) and identifies file type and conversion system (e.g., Adobe Acrobat) needed to convert document. Users are able to transmit folders (i.e., in addition to individual files) using Zip files or other means. A status bar should be viewable to the user upon upload or download of a selected file. If practicable, the Document Center provides simplified document editing tools (e.g., post-its, highlighting, etc.) whereby changes are clearly marked. Documents should be captured on the system operator's servers to ensure immediate, reliable delivery, but they are also transferable to internal company systems via e-mail, optical scanning and printing facilities. The automated risk management system should provide a notice/alert when a new document is make available in the Document Center (“A new document relating to Deal 591 has been made available to you in the Document Center . . .” with a hot-link to the document. The document delivery system provides internal tracking (e.g., return receipt requested) to ensure secure, reliable delivery to the intended party.

The automated risk management system provides a Trade Calendar functionality enabling users to create and distribute simplified digital calendars outlining their deal making schedules for particular deals (e.g., “Deal #591 Responses/Authorizations Required by Friday, Nov. 1, 1999, 5:00 pm EST . . . ”).

The automated risk management system provides a digital signature functionality enabling the electronic binding and authorization of individual deals and/or participations on deals by transacting parties. This functionality provides appropriate password protection and/or other security measures to ensure the strict integrity of the authorization process.

The automated risk management system provides suitable auction/syndication engines to facilitate the conclusion of one-to-one or one-to-many deals among transacting parties on the system.

The automated risk management system enables users to elect to participate in a real-time on-line trader directory identifying the set of traders logged on to the system at any particular time. This directory assists users in making use of real-time communication facilities (e.g., real-time text dialog) without being required to make a prior appointment with other participating traders.

The automated risk management system provides a communication functionality enabling the transmission of real-time text dialog & whiteboard among transacting parties. The automated risk management system provides a user-friendly set-up procedure to coordinate and initiate each planned session. The contents of each dialog/whiteboard session should be automatically saved as a file to the Communications In-box and Trade Archive.

The automated risk management system enables multiple users to engage in real-time sharing and editing of documents (i.e., NetMeeting). This functionality is optionally integrated with other functionalities provided by the Document Center. This feature includes document management and “wizard” tools allowing users to assemble standardized trading documents. The automated risk management system provides a communication functionality enabling Internet telephony and video conferencing between users.

The application and system software can be implemented in a variety of programming languages and tools that are known to those skilled in the art of on line software development. Particular selections of programming languages are development tools are a matter of choice dependent on existing hardware, software and architectural structures. The choices are readily apparent to those skilled in the art on line software development.

In view of the foregoing description, numerous modifications and alternative embodiments of the invention will be apparent to those skilled in the art. It should be clearly understood that the particular exemplary computer code can be implemented in a variety of ways in a variety of languages, which are equally well suited for a variety of hardware platforms. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim, is reserved.

We claim:

1. A method for automated risk management on an automated system, the method comprising the following steps:
authenticating user access to the automated system;
providing a database of transactional postings;
enabling a first user to access the transactional postings including a specific posting by a second user;
enabling private anonymous communication between the first user and the second user;
wherein the first user and the second user are identified to the automated system.

2. The method as recited in claim 1 further comprising the step of enabling mutual consent between the first user and the second user to simultaneously identify the first user and the second user identified to each other.

3. The method as recited in claim 2 further comprising the step of enabling identified users to select to automatically include their identity in all subsequent communications between the first user and the second user with respect to the particular transaction.

4. The method as recited in claim 1 wherein the transactional postings correspond to risk positions.

5. The method as recited in claim 1 wherein the specific posting includes information corresponding to interest of the poster to buy, sell or swap the particular risk position.

6. The method as recited in claim 1 wherein the specific posting includes information corresponding to market type of the particular risk position.

7. The method as recited in claim 1 wherein the specific posting includes information corresponding to risk instrument of the particular risk position.

8. The method as recited in claim 1 wherein the specific posting includes information corresponding to market geographical scope of the particular risk position.

9. The method as recited in claim 1 further comprising the step of filtering access to the transactional postings, wherein specific transactional postings are filtered before accesses is provided to a particular user based upon predefined criteria of the particular user.

10. The method as recited in claim 1 wherein the private anonymous communication uses a world wide computer network.

11. A system for automated risk management on an automated system used by a plurality of users comprising:
means for authenticating the plurality of users to access to the automated system;
means for providing a database of transactional postings;
communication means for a first user of the plurality of users to access the database of transactional postings including a specific posting by a second user of the plurality of users;
anonymous communication means for private anonymous communication between the first user and the second user;
wherein the first user and the second user are identified to the automated system.

12. The system as recited in claim 11 further comprising identification means to simultaneously identify the first user and the second user identified to each other upon mutual consent between the first user and the second user.

13. The system as recited in claim 12 further comprising means for identified users to select to automatically include their identity in all subsequent communications between the first user and the second user with respect to the particular transaction.

14. The system as recited in claim 1 1 wherein the transactional postings correspond to risk positions.

15. The system as recited in claim 11 wherein the specific posting includes information corresponding to interest of the poster to buy, sell or swap the particular risk position.

16. The system as recited in claim 11 wherein the specific posting includes information corresponding to market type of the particular risk position.

17. The system as recited in claim 11 wherein the specific posting includes information corresponding to risk instrument of the particular risk position.

18. The system as recited in claim 11 wherein the specific posting includes information corresponding to market geographical scope of the particular risk position.

19. The system as recited in claim 11 further comprising the step of filtering access to the transactional postings, wherein specific transactional postings are filtered before accesses is provided to a particular user based upon predefined criteria of the particular user.

20. The system as recited in claim 11 wherein the private anonymous communication uses a world wide computer network.
